(19) United States
(12) Patent Application Publication
(10) Pub. No.: US 2023/0010394 A1
(43) Pub. Date: Jan. 12, 2023

(54) ROCK PROCESSING MACHINE INCLUDING IMAGE ACQUISITION AND IMAGE PROCESSING BY A NEURAL NETWORK

(71) Applicant: Kleemann GmbH, Göppingen (DE)

(72) Inventors: Steffen Häberle, Herbrechtingen (DE); Till Krauss, Rechberghausen (DE); Jochen Meier, Hülben (DE)

(21) Appl. No.: 17/845,551

(22) Filed: Jun. 21, 2022

(30) Foreign Application Priority Data
Jul. 7, 2021 (DE) 10 2021 117 537.2

(51) Int. Cl. B02C 25/00; G06V 10/25; G06V 10/764; G06V 10/82; B02C 21/02

(52) U.S. Cl. CPC B02C 25/00; G06V 10/25; G06V 10/764; G06V 10/82; B02C 21/026

(57) ABSTRACT

A rock processing machine is disclosed for crushing and/or grain size-dependent sorting of pourable rock material. The rock processing machine comprises a rock processing device having a crushing crusher device and a sorting screen, at least one camera system in whose field of view in the operation of the machine a surface of the pourable rock material is located, and a data processing device configured to process image data of the camera system via an artificial neural network. The data processing device is configured to ascertain at least one image area portion in image data recorded and transmitted by the camera system as an image object and to classify the ascertained image object by using the artificial neural network with respect to at least one object property from among a group of object properties comprising: object shapes; object sizes; object types; and/or object materials.

### CROSS-REFERENCES TO RELATED APPLICATIONS

This application claims benefit of German Patent Application No. DE 10 2021 117 537.2, filed Jul. 7, 2021, and which is hereby incorporated by reference.

### FIELD OF THE INVENTION

The present invention relates to a rock processing machine for performing at least one of the following processing steps: crushing, grain size-dependent sorting and conveying pourable rock material. More particularly, the present invention may relate in various embodiments to mobile rock processing machines, which comprise a drive device and a traveling gear, so that as self-propelled rock processing machines they are able to change location independently of tractors.

### BACKGROUND

A rock processing machine for crushing pourable rock material is for example a crusher, such as a cone crusher, a jaw crusher, an impact crusher, a roll crusher, and the like. A rock processing machine for sorting pourable rock material according to grain size is for example a screening plant. A rock processing machine for conveying may be for example a so-called stacker. In this context, a rock processing machine may be designed for crushing as well as for sorting and/or conveying rock material. A rock processing machine as conventionally known and also as referred to herein simply as “machine” therefore has at least one rock processing device made up of at least one crushing crusher device and at least one sorting screening device. For monitoring and supporting a control system of a rock processing operation at the machine, the rock processing machine comprises at least one camera system, a surface of the pourable rock material being located in the field of view of the camera system in the operation of the machine. This makes it possible for the camera system of a rock processing device to record rock material supplied to or removed from the rock processing device and to provide image data that represent the recorded rock material. The machine further comprises a data processing device, which is designed to process image data of the camera system by using an artificial neural network.

A rock processing machine of this type in the form of a crushing machine is known from WO 2019/053261 A1. This printed publication discloses very generally an operating method for a rock crushing machine, according to which at least one sensor signal is obtained, which relates to the supply of rock to the crushing machine. The sensor signal may be obtained for example by image acquisition.

A first crushing parameter of the supplied rock is determined from the at least one sensor signal by using a model. By using at least one parameter of the crushing machine and/or of a crushing device in the crushing machine, a second crushing parameter is determined.

With the aid of the second crushing parameter as a correction parameter and of the at least one sensor signal, the model is updated, by the use of which the first crushing parameter is determined from the at least one sensor signal.

According to WO 2019/053261 A1, the definition of a first crushing parameter of the rock to be processed and/or the updating of a model may be achieved inter alia by multilayered learning methods (“deep learning”) or by an artificial neural network.

The second crushing parameter is determined on the basis of at least one parameter from the energy consumption of at least one crushing device, a charging or filling level of a crushing device, a speed of a crushing device, a unit charge of the crushing device, an initial grain size supplied to the crushing device and a grain size discharged from the crushing device.

The first and/or the second crushing parameter(s) is or are a work or performance index or a set of work and performance indices.

The first crushing parameter is used to control the crushing machine. This control system comprises an adaptation of the charging of the machine, an adaptation of a supply tonnage, an adaptation of a water supply, a modification of the rock mixture, an adaptation of conveyor belt speeds and an adaptation of the speed of the crushing device.

WO 2019/053261 A1 does not go beyond this general disclosure with respect to the use of neural networks in a control device of a crushing machine.

DE 10 2019 204 103 A1 discloses a method for the rough classification of the particle size distribution of a bulk material by using classical image processing. According to DE 10 2019 204 103 A1, a surface of the bulk material is recorded by a camera. Contiguous areas are sought in this recording and a representative diameter is ascertained for each identified contiguous area. The average value and dispersion are determined for the ascertained diameters. A product of the average value and the dispersion is ascertained as a classifier.

### BRIEF SUMMARY

Embodiments of a rock processing machine as disclosed herein may accordingly support the operator of a rock processing machine by developing the machine mentioned at the outset further and to make it possible to control the rock processing performed in the machine according to criteria that are as objective as possible.

As disclosed herein, such embodiments may include a rock processing machine whose data processing device is designed to ascertain at least one image area portion in image data recorded and transmitted by the camera system as an image object and to classify the ascertained image object by using the artificial neural network with respect to at least one object property of the following object properties:
object shape,
object size,
object type and
object material.

In this context, the possibility shall not be excluded that the image object ascertained from the image data is also ascertained with the aid of an artificial neural network. Normally, however, classical image processing methods suffice in this context to ascertain image area portions in image data of a camera system as image objects.

It is more important that the image objects, once ascertained, are classified by an artificial neural network and thus are detected not only in their existence, but, as it were, in their relevance for the rock processing performed in the machine. For this purpose, the artificial neural network is able to use semantic segmentation in order to assign at least one of the mentioned object properties to a pixel or to a group of pixels.

In a correct ascertainment of image objects from the image data of the at least one camera system, the ascertained image object represents a real phenomenon, which may be recognized by the classification as a physical object supplied to a rock processing device and may be distinguished from non-physical phenomena, such as “sky” for example, or from physical objects that are not provided for processing, such as sections of the rock processing machine for example.

Regarding the object form, a distinction may be made between round and angular image objects for example. Within the class of round image objects, it is possible to distinguish between rather spherical and rather elongated, that is, ellipsoidal image objects. Additionally or alternatively, recognized angular image objects may be distinguished in terms of the number of their edges and/or mutually angled surfaces. It is of course obvious that the rock material to be processed or processed in a rock processing machine has no regular geometries. Nevertheless, it is possible to distinguish degrees of different angularity of the ascertained image objects, for example a high, average, or low angularity, on the basis of threshold values, which are exceeded or undershot.

Likewise, an object size may be ascertained for example as a greatest dimension occurring in the processed image data of an image object to be classified with respect to its object size, as an average dimension of a plurality of differently oriented dimensions of the image object or as an edge length or diagonal of a frame or box framing the image object in the image data. For example, via the ascertainment of object sizes of multiple objects detected by the camera system, which were ascertained as image objects in the image data, it is possible to ascertain an object size distribution in the field of view of the camera system. This makes it possible to distinguish whether the pourable rock material contains few large objects and, comparatively, numerous very small objects, or whether the rock material is rather homogeneous and essentially comprises objects of one and the same size class.

Regarding the object type, it is possible to distinguish between object types that the rock processing machine or at least one of its rock processing devices is fundamentally able to process and types of objects that cannot be processed. Especially if for example broken concrete is entered into the rock processing machine as pourable rock material, the entered material often also contains foreign material made of metal, such as reinforcements and the like, or made of wood, which the rock processing machine is either not able to process and which must therefore be screened out if indicated, or which are not intended for processing by the rock processing machine. The object type is thus able to distinguish between rock and foreign body and within these object types, depending on further classified object properties, according to different rock types and/or according to different foreign bodies.

The classification according to object material may help to distinguish different rock materials, as well as further foreign materials loaded into the rock processing machine such as metal, soil, sand, wood, and the like.

The above-mentioned object properties do not represent a conclusive list. Further object properties, such as object humidity, etc., may be added to the four mentioned particularly important object properties.

Particularly preferably, by using the artificial neural network, the data processing device is able to ascertain a plurality, preferably all, of the aforementioned object properties, in order to ascertain in this manner a recognition, evaluation or assessment of the pourable rock material loaded into the rock processing machine that is as comprehensive as possible.

The evaluative processing of the image material of the camera system with the aid of an artificial neural network makes it possible to render the recognition and assessment of the rock material loaded into the rock processing machine objective, independent of the subjective perception of the machine operator. Furthermore, it is possible to relieve the machine operator of the tasks assumed by the neural network. The machine operator is thus able to spend more time attending to other tasks. If human intervention in the rock processing operation by the machine should be necessary, the machine operator is able to perform such an intervention as before. This is normally necessary much less often, however, than without the present invention.

The camera system may comprise one or multiple cameras. In the case of the use of multiple cameras in a camera system, the fields of view of the individual cameras of the same camera system may overlap so as to use a further camera to capture areas of the pourable rock material that are concealed in the perspective of one camera. The fields of view of the individual cameras may furthermore adjoin one another partially or entirely, so that multiple cameras or each camera of the same camera system capture(s) another area of a surface of rock material. This makes it possible to obtain a particularly large cumulative field of view of the camera system from the individual fields of view of the cameras.

The field of view of a camera system may be directed onto a section of a conveyor line for conveying rock material at or in the machine. The conveyor line may be formed by a belt conveyor device, a vibrating conveyor, and the like. The field of view of the camera system then forms a segment that is normally fixed relative to the machine frame of the rock processing machine, through which rock material is conveyed in the operation of the machine.

Alternatively or additionally, the field of view of a camera system may be directed onto a section of a screening device, for example onto its material feed or onto the charge loaded on the screen.

Basically, at least one camera system may be situated in the flow of the pourable rock material upstream from the rock processing device. On the basis of the at least one camera system and the data processing device it is then possible to assess the rock material still to be processed in the machine. On the basis of this assessment, operating parameters of the machine may be set or changed, if indicated. Additionally or alternatively, at least one camera system may be situated downstream from the rock processing device. In this case, using the at least one camera system, it is possible to detect and assess pourable rock material as the result of processing by the rock processing device. If indicated, operating parameters of the machine may thus be determined or selected, set, or changed on the basis of an assessment of the achieved processing result.

Preferably, at least one camera system is situated upstream and at least one camera system is situated downstream from the rock processing device, so that not only the rock material to be processed by the rock processing device, but also the processing result achieved by the rock processing device is detectable in automated fashion and assessable by the artificial neural network, which allows for a particularly precise automated process control of the rock processing device.

As was already indicated by the preceding description, for the purpose of making further objectified use of the findings about the pourable rock material in the machine obtained from the image data, the data processing device may be designed to change at least one operating parameter of the rock processing machine on the basis of the at least one classified object property and/or to inform a machine operator about a recommended change of operating parameters. For this purpose, the data processing device is able to assign quantitative parameter values to the pourable rock as a whole or to individual detected objects, for example on the basis of classified object properties by querying data relationships between object properties and their parametric evaluations stored in data memories of the data processing device. As merely one of many possible examples, reference is made to the assignment of quantitative parameter values representing hardness and/or strength values of classified materials as possible quantitative parameter values. Starting from such ascertained parameter values, the data processing device is able to intervene in controlling or regulating fashion in the operation of the rock processing machine or of a concrete rock processing device.

Depending on the nature of the rock processing device controlled or regulated by the data processing device, the operating parameter of the at least one rock processing device changeable by the data processing device may be at least one parameter selected from the following:
crushing gap width of a crusher device,
drive speed of a crusher device,
filling ratio of a crusher device,
conveying speed of a conveyor device conveying the pourable rock material,
movement frequency of at least one screen,
movement amplitude of at least one screen,
identification of at least one, preferably separate, discharge conveyor device to be controlled,
inclination and orientation of at least one conveyor device,
distance of a magnetic separator, for example from a conveyor device, in particular from a surface of the conveyor device carrying material or from the surface of the conveyed material,
magnetic performance of the magnetic separator,
drive speed of an air separator, and
volumetric flow of the air separator.

This list is also not conclusive, but indicates merely an advantageous set of parameters, which are changeable by the data processing device. For changing operating parameters, the data processing device is able to control actuators, which effect a change of at least one of the aforementioned operating parameters in the respective rock processing device. Such actuators also include the drive motor of a crusher device, a drive motor of a conveyor device for conveying the rock material, a drive motor of a screen and a switchable gear unit possibly arranged in between the drive motor and the driven device.

The aforementioned discharge conveyor device may be a conveyor device developed separately of the rock processing device, such as a stacker or the like. Known track-mounted self-propelled stackers are sold by the applicant under the trademark MOBIBELT®.

Additionally or alternatively to the aforementioned database-based parameterization of classified object properties by the data processing device, the data processing device may be designed to ascertain on the basis of the at least one classified object property at least one quantitative value of
an, optionally weighted, average value of the object size distribution of one and the same object type,
the number of objects classified per unit of time,
the number of different object types classified per unit of time,
the number of different object shapes classified per unit of time,
the number of different object materials classified per unit of time, and
an, optionally weighted, average value of a parameter representing different object types and/or object shapes and/or object materials and/or object sizes

This evaluation of the classified object properties makes it possible to express at least one property of the pourable rock material as a whole quantitatively and to process it as data. As indicated above, statistical evaluation methods, in particular methods of descriptive statistics, may be used for this evaluation. These quantitative values may then also be used for controlling or regulating the rock processing machine or at least one of its rock processing devices.

For this purpose, the data processing device is not only able to intervene in the operation of the at least one rock processing device processing the rock material in controlling or regulating fashion, but it is also able to respond to detected imminent problems in the processing of the rock. In particular in connection with the evaluation of image data of at least one camera system situated upstream of a rock processing device, in the event that as a result of a classification of an image object according to the type of object, the data processing device classifies the image object as a foreign object that cannot be processed in at least one rock processing device of the rock processing machine, the data processing device may be designed to output a message to the machine operator indicating the foreign object and/or to start a separation process for separating the foreign object from the flow of material of the rock processing machine using a separation device. Such a separation device may be a mechanical gripper or slider, which removes the foreign object from the flow of material. Additionally or alternatively, the separation device may comprise a magnet, in order to remove frequently recurring foreign objects such as reinforcements made of soft magnetic steel from the flow of material by using magnetic forces of attraction. It may suffice, however, merely to output a message to the machine operator, who is then called upon to make a decision regarding the separation of the foreign object and to carry it out if indicated.

According to one possible development of the present invention, upon classifying an image object as a foreign object, as a function of its likewise classified objects size and classified object material, it is possible that the data processing device initiates no measure for small and/or unstable foreign objects, that it outputs a warning to the machine operator for medium-sized foreign objects and/or foreign objects of average stability, and that it prompts an automated separation process or a standstill of the conveyor currently conveying the foreign object for foreign objects that present a danger for the integrity of the downstream rock processing device on account of their size and/or stability.

By classifying image objects using an artificial neural network, the data processing device is also able to ascertain specifically the capacity utilization of at least one rock processing device and/or of the entire rock processing machine. A capacity utilization ascertained in this manner can also be a basis for a controlling intervention of the data processing device in the operation of the rock processing machine. When it determines that a predetermined threshold number of objects classified by the at least one rock processing device as processable per unit in time is reached or undershot, or when it determines that a threshold volume is reached or undershot by an object volume formed from a combination of the number of objects and the object size, the data processing device may therefore be designed to initiate at least one of the following actions:
transmitting corresponding information to a charging device cooperating with the rock processing machine,
transferring the rock processing machine into an operating mode that consumes less energy per unit of time, and
stopping the rock processing machine.

As was already explained above, for achieving the best possible automated control or regulation of the rock processing performed within it, the presently discussed machine has at least two camera systems, each of the at least two camera systems recording the pourable rock material at a different location in its associated field of view along the flow of material in the rock processing machine. For an advantageously lean image processing operation by an artificial neural network with the lowest possible resource requirement for data storage, the data processing device is designed to classify ascertained image objects in image data from at least two of the at least two camera systems on the basis of the same ground truth regarding at least one object property. The number of camera systems is thus preferably independent of the number of ground truths, on the basis of which object properties are assigned to image objects detected in image data of the machine. Consequently, it may suffice to provide preferably a single database at the machine, from which the artificial neural network processes image data of different camera systems.

The artificial neural network may initially be trained at the facility of the machine manufacturer, where flows of material of known pourable rock material are detected by at least one camera system and the image data thus obtained are processed for ascertaining image objects. By manual or partially automatic semantic segmentation, at least one object property of the known pourable rock material may then be assigned to each of the individual pixels of the image data. In this manner, a ground truth may be successively worked out, on the basis of which the artificial neural network automatically applies semantic segmentation to the pixels of the image objects of the image data of the respective machine and thus classifies the ascertained image objects.

It is advantageous in this regard if the respective rock processing machine is able to develop the ground truth provided in its delivery state further or to develop the database provided as the working basis of the image-processing artificial neural network further. For this reason, the data processing device in various embodiments as disclosed herein comprises a training mode, in which the operator is able to train the artificial neural network used by the data processing device on the basis of image data of at least one camera system of the rock processing machine. The training mode may be activated and also terminated manually by the operator.

In order to develop the artificial neural network further effectively, the training mode allows for at least one of the following actions:
assigning object properties to image data by an operator, and
entering object properties of a known rock material loaded into the rock processing machine and automatically assigning the entered object properties to ascertained image objects in acquired image data.

Thus, a type of automated learning of the artificial neural network is also conceivable in that for example a homogeneous known rock material is loaded into the machine, whose grain size, material, shape etc. are known. In this case, it may suffice to enter the known object properties into the data processing device and to let the artificial neural network assign these in a training process in automated fashion to image objects ascertained in image data of the known rock material.

The likewise mentioned manual or partially automatic assignment of object properties to image data or to ascertained image objects by an operator, however, offers greater variability compared to the automated learning method described above because it is not necessary to load known rock material into the machine, but rather the rock material currently located in the machine can be analyzed by the specialist knowledge of the operator and the result of the analysis may be entered manually into the artificial neural network by semantic segmentation.

Even though a training of the artificial neural network of the machine at the machine may basically be preferred in various embodiments, such a training mode requires considerable data processing resources at the rock processing machine. For this reason, to avoid such extensive data processing resources, the rock processing machine may comprise a data transmission device, which is designed to transmit image data of at least one camera system to a remote data processing device located at a remove from the rock processing machine. In this manner, image data of a real rock processing operation may be transmitted to the remote data processing device, where sufficient data processing resources are provided in order to develop the artificial neural network of the machine further in a learning method on the basis of the transmitted image data. For example, a copy of the artificial neural network of the machine may be installed at the remote data processing device, which is developed further by the training process. Following the training process, by data transmission to the machine, it is possible to update the artificial neural network of the machine to the stage of development of the artificial neural network of the remote data processing device. Such an update may be performed immediately following the conclusion of the training process or may be performed in the context of a machine maintenance or regular update cycles.

For performing a further development of the artificial neural network of the rock processing machine at a location remote from the rock processing machine, the machine may be coupled at least temporarily to the remote data processing device in a data-transmitting manner, the remote data processing device being designed to allow an assignment of object properties to image data transmitted from the rock processing machine and thereby to generate an expanded ground truth of the artificial neural network of the rock processing machine, the expanded ground truth being transmittable to the data processing device of the rock processing machine for use by the artificial neural network of the rock processing machine. The transmission of the data back to the machine may occur via the data transmission link, for example by radio communication, for example via a mobile telephony network or the like, or may occur by physical data carriers, such as DVD or USB stick, if the update of the artificial neural network is to be performed by planned updates or in the course of machine maintenance.

Convolutional neural networks have proven to be particularly powerful for classifying image objects recognized in image data, which is why the artificial neural network used by the rock processing machine may preferably be a convolutional neural network.

Part of the image processing may be the monitoring of the image quality provided by the at least one camera system. Thus, the data processing device may be developed to ascribe a quality value representing the quality of the image data to the image data of the camera system, be it during the image processing operation for example or for example in a separate quality assurance method. Such a quality value may take into account for example the contrast in the image data and/or the noise contained in the image data and/or the image sharpness of the image data. Thus, in a further development of the invention, the data processing device designed in this manner may be developed to output a warning signal and/or to terminate an automated process management of the rock processing in the machine in the event that a quality value ascribed to the image data of a camera system does not achieve a predetermined minimum quality value required for reliable image processing. The warning signal preferably has the content of informing the operator working on the machine about the termination of automated operating parameter adaptations.

Since it is possible that the image data processing described above and possibly the resulting operational control of a rock processing operation is performed not only on a single rock processing machine, but rather on multiple cooperating rock processing machines, the present invention also relates to a rock processing plant, comprising at least two rock processing machines as described and developed above. These rock processing machines of the rock processing plant are situated sequentially in a common rock material flow of the plant so that the rock processing machine downstream in the rock material flow of the plant receives rock material that was previously processed by the upstream rock processing machine of the at least two rock processing machines. Since a rock processing machine thus receives the processing result of another rock processing machine, at least one operating parameter of a rock processing operation by the downstream rock processing machine may be changeable on the basis of an object property classification by the artificial neural network of the upstream rock processing machine. This is advantageous for example when a camera system of the upstream rock processing machine records rock material processed by the upstream rock processing machine, the artificial neural network processes the image data of this camera system and on this basis controls the rock processing operation of the downstream machine.

Due to their great conveyor lengths, compared to crusher and screening plants, the previously mentioned stackers or conveyor belts generally are often well-suited to generate and collect data about the conveyed pourable rock material at, in particular over, their conveyor path using the image processing operation described in the present application and to transmit these data to a rock processing machine subsequently receiving the rock material.

Alternatively or additionally, it is conceivable that the camera system of the upstream rock processing machine transmits only its image data to a data processing device of the downstream machine and that the latter ascertains image objects in the image data, classifies these using a neural network and controls the downstream machine on the basis of this classification result.

Of special significance are the methods described above for updating and developing an artificial neural network, which is used for classifying ascertained image objects in a rock processing machine, as it is described and developed above, or on a rock processing plant as previously described and developed. That is why the present invention also relates to such methods, which may comprise the following steps:
a) acquiring image data of a pourable rock material in the rock processing machine or rock processing plant,
b) ascertaining image objects in the acquired image data by an image processing device or by an operator.

In the event that the updating method is a manual updating method, that is, one performed by an operator, the updating method preferably comprises the following further method steps:
c1a) assigning object properties to the ascertained image objects by an operator, and
c1b) weighting connections between neurons of the artificial neural network on the basis of the generated assignment of image objects and object properties.

However, in the event that the updating method is an automated method as already described above, the method comprises, prior to steps a) and b), loading a known rock material into the rock processing machine or rock processing plant.

In the automated updating method, prior to or following the loading of the known rock material, object properties of the known rock material are entered into the data processing device. The data processing system may then perform an automated assignment of object properties to the ascertained image objects.

Connections between neurons of the artificial neural network are weighted on the basis of the generated assignment of image objects and object properties.

In the event that the updating method is a remote updating method, the method comprises a transfer of the image data, with or without the ascertained image objects, to a remote data processing device. This method step may be followed by the following further method steps:
c3b) assigning object properties to the transmitted image data, in particular image objects, by an operator and/or by the remote data processing device,
c3c) weighting connections between neurons of the artificial neural network on the basis of the generated assignment of image objects and object properties,
c3d) transmitting the ascertained connection weights to at least one rock processing machine or rock processing plant, preferably to a plurality of rock processing machines and/or rock processing plants.

### BRIEF DESCRIPTION OF THE SEVERAL VIEWS OF THE DRAWINGS

FIG. 1 is a rough schematic elevation view of a specific embodiment of a rock processing machine as disclosed herein.

### DETAILED DESCRIPTION

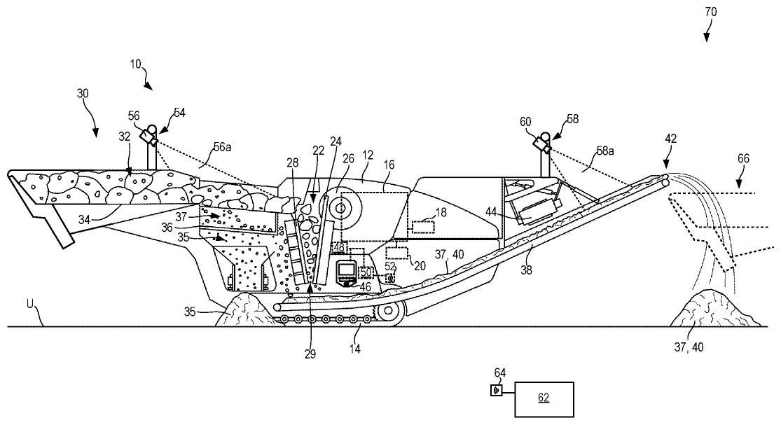

An exemplary rock processing machine is generally denoted by 10 in FIG. 1. The machine 10 comprises a machine frame 12, which stands on a contact subsurface U via a crawler undercarriage 14 that is known per se. The machine 10 is therefore a mobile rock processing machine 10, which with its crawler undercarriage 14 is able to drive independently at least from a transport device, such as a flat-bed vehicle for example, to its site of operation.

The machine 10 comprises a combustion engine 16, for example a diesel engine, which forms a central power plant of machine 10. The combustion engine 16 may drive for example a hydraulic motor 18 and an electrical generator 20, so that when the combustion engine 16 is in operation, a predetermined hydraulic pressure level and an electrical energy supply beyond electrical energy merely stored in batteries is available.

The machine 10 has a first rock processing device, namely, a jaw crusher 22. The right crushing jaw 24 in FIG. 1 is driven by an eccentric 26 to perform a reciprocal movement toward and away from the left crushing jaw 28 in FIG. 1, which is fixed to the machine frame, in a pulsating change of the crushing gap 29 existing between the crushing jaws 24 and 28. The movement of the eccentric 26 is provided by the combustion engine 16.

Via a charging unit 30, the jaw crusher 22 is charged with material 32 to be crushed in the jaw crusher 22. As a conveyor device, the machine 10 has a charging chute 34, which conveys the material 32 charged therein as a vibrating conveyor to a double-deck primary screen 36. The double-deck primary screen 36 in operation is driven to circular vibration and forms a second rock processing device. Here, a fine fraction 35 and a fraction 37 having medium-sized grain are separated from material 32 and are conveyed separately from the rest of the material 32. The fine fraction 35 may be discharged from the machine 10, for example. The fraction 37 having a medium grain size may be conveyed directly onto the crusher discharge conveyor belt 38 as a further conveyor device, which also conveys the crushed material 40 emerging from the jaw crusher 22 after passing through it away from jaw crusher 22 to a discharge location, from where the material 40, which was crushed as intended, is heaped up.

Along the conveyor path from the crushing gap 29 to the discharge location 42, the material 37 and 40 is conveyed past a magnetic separator 44. The electrically driven magnetic separator 44, which magnetically separates ferromagnetic portions, such as steel reinforcements, from the crushed material 37 and 40 and conveys the separated ferromagnetic material away from machine frame 12 in a direction projecting from the drawing plane of FIG. 1, is a separation device in the sense of the introduction of the description.

The machine 10 may be operated and controlled via an operating console 46 situated laterally on the machine frame 12 by way of example. The operating console 46 is connected for data transmission to a data processing device 48 and a data storage device 50. Data storage device 50 is likewise connected to the data processing device 48.

The data processing device 48 is very generally designed for data processing on the rock processing machine 10, also for image processing. It is also used for controlling operational sequences and is therefore also a control device of the rock processing machine 10. The control device of machine 10 may be developed separately from the data processing device 48 as an independent device, so that the machine 10 then comprises a control device normally comprising microprocessors and a data processing device 48 normally also comprising microprocessors. The two separate devices then differ with respect to the data processing operations running within them.

Data storage device 50 stores parameters for a neural network, which is developed as hardware in data processing device 48 by an appropriate interconnection of microprocessors. Additionally or alternatively, the neural network may also be implemented as software by a corresponding program.

The ground truth on which the neural network was trained is stored for example in data storage device 50. The neural network is a convolutional neural network especially suited for the present data processing purpose of an automated classification of ascertained image objects.

The data processing device 48 and with it the data storage device 50 are connected to a transmitting and receiving data transmission device 52, for example a radio antenna. The data transmission device 52 may operate for example in accordance with the UMTS or 5G standard. Other data transmission devices 52 are likewise conceivable, for example WLAN access points, which may be in radio communication with further WLAN access points outside of machine 10. The further WLAN access points may then be connected by a cable to a data transmission network.

Above the charging unit 30, more precisely the charging chute 34, a frame 54 is situated, which supports a first camera system 56. The field of view 56a of the first camera system 56 is directed onto the carrying side of the charging chute 34 and thus onto the rock material 32, which in the operation of machine 10 is fed to the rock processing devices 36 (double-deck primary screen) and 22 (jaw crusher).

The first camera system 56 supplies image data to the data processing device 48, which ascertains image objects in the image data, for example as contiguous, sufficiently homogeneous image areas. On the basis of the ground truth available to it, the neural network implemented in the data processing device 48 then classifies the image objects according to object shape, object size, object type and object material. On the basis of a brightness or relative brightness of a recognized object material, the neural network is possibly also able to infer an object moisture.

Starting from the object properties of the ascertained image objects classified in this manner, the data processing device 48 is able to ascertain the processing conditions to be expected by application of statistical methods known per se and to derive therefrom the required operating parameters, with which the rock processing devices 22 and 36 as well as the conveyor devices 34 and 38 are to be operated in order to achieve the desired processing result, for example regarding the achieved grain size.

Above the crusher discharge conveyor belt 38, a further frame 58 is situated including a second camera system, whose field of view 60a is directed onto the carrying side of the crusher discharge conveyor belt 38 and thus, during the operation of machine 10, onto the pourable rock material 37 and onto the pourable crushed rock material 40 on the crusher discharge conveyor belt 38.

The second camera system 60 also provides image data of the rock materials 37 and 40 to the data processing device 48, in which image objects are ascertained in the same manner as from the image data of the first camera system 58 and are classified using the same neural network of the data processing device 48 on the basis of the same ground truth. The classified image objects in turn may be processed further by the data processing device 48 by application of statistical methods for assessing the rock materials 37 and 40.

On the basis of the data processing results of the image data of the second camera system 60, the data processing device 48 is able to check whether the desired work result was obtained, for example whether the rock material was crushed sufficiently, and is able, if indicated, to change the operating parameters of the rock processing devices 22 and 36 on the basis of the image data of the second camera system 60 and their processing by the neural network and, if indicated, by using statistical methods, in order to adapt the actually obtained processing result to the desired target processing result. At the same time, contaminations (binding material, foreign bodies) may be detected and characteristics regarding the quality of the end product or of an intermediate product may be ascertained at the rock processing machine 10.

At the same time, the neural network is able to use this correlation of input rock and processed or crushed rock from the image data of the camera systems 56 and 60, in order to improve the control behavior of data processing device 48 on the basis of the rock material 32 input into machine 10. Thus, in subsequent rock processing sequences, immediately after classifying the input pourable rock material, possibly following further statistical processing of the classification data, it is possible to set more appropriate operating parameters for operating the rock processing devices 22 and 36 at an earlier point in time in the processing sequence than in an earlier rock processing sequence.

If one of the camera systems 56 or 60 records image data, which the neural network existing in machine 10 is only insufficiently capable of classifying, these image data may be transmitted via data transmission device 54 to a remote data processing device 62, which likewise has a data transmission device 64. There, the image data may be processed and image objects ascertained therein may be classified by manual semantic segmentation. The ground truth developed further in this manner may be transmitted back to machine 10 via data transmission devices 54 and 64. In this manner, it is possible continuously to improve and develop the neural network of machine 10.

In the event that a processing result of machine 10, for example the rock materials 37 and 40 on the crusher discharge conveyor belt 38, forms the starting material for a further rock processing machine 66, the second camera system 58 of the rock processing machine 10 is able to serve as the first camera system 58 of the further rock processing machine 66. The data transmission device 54 may then transmit the image data or the already classified and possibly statistically processed classified image object information to the data transmission device of the further rock processing machine 66, which either controls its rock processing devices using its control and/or data processing device on the basis of this image object information or which compares or adjusts the transmitted image object information with image object information obtained by its own camera system or its own neural network and then takes control measures such as selecting operating parameters and adjusting rock processing devices and conveyor devices in accordance with the selected operating parameters.

The rock processing machines 10 and 66 form a rock processing plant 70.

1-16. (canceled)

17. A rock processing machine for crushing and/or grain size-dependent sorting and/or conveying of pourable rock material, the rock processing machine comprising:
at least one rock processing device comprising at least one crushing crusher device and at least one sorting screen;
at least one conveyor device configured to convey the pourable rock material;
at least one camera system in the field of view of which, in the operation of the machine, a surface of the pourable rock material is located; and
a data processing device configured to
process image data of the camera system by using an artificial neural network,
ascertain at least one image area portion in image data recorded and transmitted by the camera system as an image object, and
classify the ascertained image object by using the artificial neural network with respect to at least one object property selected from among an object shape, an object size, an object type, and/or an object material.

18. The rock processing machine of claim 17,
wherein the at least one camera system is situated upstream and/or downstream from the rock processing device in the flow of the pourable rock material.

19. The rock processing machine of claim 17,
wherein the data processing device is configured to change at least one operating parameter of the rock processing machine based on the at least one classified object property and/or to inform a machine operator about a recommended change of operating parameters based on the at least one classified object property.

20. The rock crushing machine of claim 19, wherein the at least one operating parameter of the at least one rock processing device changeable by the data processing device comprises a:
crushing gap width of a crusher device;
drive speed of a crusher device;
filling ratio of a crusher device;
conveying speed of a conveyor device;
movement frequency of at least one screen;
movement amplitude of at least one screen;
identification of at least one discharge conveyor device to be controlled;
inclination and orientation of at least one conveyor device;
distance of a magnetic separator from a device or surface;
magnetic performance of the magnetic separator;
drive speed of a wind sifter; and/or
volumetric flow of the wind sifter.

21. The rock processing machine of claim 19, wherein the data processing device is configured to ascertain, based on the at least one classified object property, at least one quantitative value comprising a:
weighted average value of an object size distribution of one and the same object type;
number per unit of time of classified objects;
number of different object types classified per unit of time;
number of different object shapes classified per unit of time;
number of different object materials classified per unit of time;
weighted average value of a parameter representing different object types and/or object shapes and/or object materials and/or object sizes; and/or
statistical evaluation of at least one of the aforementioned parameters.

22. The rock processing machine of claim 19, wherein the rock processing device is configured, upon classifying an object as a foreign object that at least one rock processing device of the rock processing machine is unable to process, to
output a message to a machine operator indicating the foreign object, and/or
start a separation process for separating the foreign object from a flow of material of the rock processing machine via a separation device.

23. The rock processing machine of claim 19, wherein the rock processing device is configured, upon determining a reaching or undershooting of a predetermined threshold number of objects per unit of time classified as processable by the at least one rock processing device, to initiate at least one action comprising:
transmitting corresponding information to a charging device cooperating with the rock processing machine;
transferring the rock processing machine into a mode consuming less energy per unit of time; and/or
stopping the rock processing machine.

24. The rock processing machine of claim 17, comprising:
at least two camera systems having fields of view each detecting along the flow of material at different locations in the rock processing machine,
wherein the data processing device is configured to classify ascertained image objects in image data of at least two of the at least two camera systems based on the same ground truth regarding at least one object property.

25. The rock processing machine of claim 17,
wherein the data processing device comprises a training mode, enabling training of the artificial neural network used by the data processing device based on image data of at least one camera system of the rock processing machine.

26. The rock crushing machine of claim 25, wherein the training mode enables at least one action comprising:
assigning object properties to image data by an operator; and/or
entering object properties of a known rock material loaded into the rock processing machine and automatically assigning the entered object properties to ascertained image objects in acquired image data.

27. The rock processing machine of claim 17, comprising:
a data transmission device configured to transmit image data of at least one camera system to a remote data processing device situated at a distance from the rock processing machine.

28. The rock processing machine of claim 27,
wherein the data transmission device is coupled at least temporarily to the remote data processing device in a data-transmitting manner, and
wherein the remote data processing device is configured to allow an assignment of object properties to image data transmitted from the rock processing machine and thereby to generate an expanded ground truth of the artificial neural network of the rock processing machine, the expanded ground truth being transmittable to the data processing device of the rock processing machine for use by the artificial neural network of the rock processing machine.

29. The rock processing machine of claim 17, wherein the artificial neural network is a convolutional neural network.

30. The rock processing machine of claim 17, wherein the data processing device is configured to ascribe a quality value representing a quality of the image data to the image data of the at least one camera system during the image processing or in a separate quality assurance process.

31. The rock processing machine of claim 30, wherein the data processing device is further configured, upon determining that a quality value ascribed to the image data does not reach a predetermined minimum quality value, to output a warning signal and/or to terminate an automated process management of the rock processing in the machine.

32. A rock processing plant comprising:
at least two rock processing machines sequentially arranged in a common rock material flow of the plant;
each of the at least two rock processing machines configured for crushing and/or grain size-dependent sorting and/or conveying of pourable rock material, and comprising:
at least one rock processing device comprising at least one crushing crusher device and at least one sorting screen;
at least one conveyor device configured to convey the pourable rock material;
at least one camera system in the field of view of which, in the operation of the machine, a surface of the pourable rock material is located; and
a data processing device configured to
process image data of the camera system by using an artificial neural network,
ascertain at least one image area portion in image data recorded and transmitted by the camera system as an image object, and
classify the ascertained image object by using the artificial neural network with respect to at least one object property selected from among an object shape, an object size, an object type, and/or an object material.

33. A method for updating and developing an artificial neural network used, in a rock processing machine or an associated rock classifying plant, for classifying ascertained image objects,
wherein the rock processing machine comprises
at least one rock processing device comprising at least one crushing crusher device and at least one sorting screen,
at least one conveyor device configured to convey the pourable rock material,
at least one camera system in the field of view of which, in the operation of the machine, a surface of the pourable rock material is located, and
a data processing device configured to
process image data of the camera system by using an artificial neural network,
ascertain at least one image area portion in image data recorded and transmitted by the camera system as an image object, and
classify the ascertained image object by using the artificial neural network with respect to at least one object property selected from among an object shape, an object size, an object type, and/or an object material;
wherein the method comprises steps of:
a) acquiring image data of a pourable rock material in the rock processing machine;
b) ascertaining image objects in the acquired image data via an image processing device;
in a manual updating method:
c1a) assigning object properties to the ascertained image objects by an operator; and
c1b) weighting connections between neurons of the artificial neural network on the basis of the generated assignment of image objects and object properties; or
in an automated updating method:
c2a) entering object properties of a known rock material into the data processing device;
c2b) prior to steps a) and b): loading the known rock material into the rock processing machine;
c2c) after steps a) and b): automated assignment of object properties to the ascertained image objects by the data processing system; and
c2d) weighting connections between neurons of the artificial neural network on the basis of the generated assignment of image objects and object properties; or
in a remote updating method:
c3a) transmitting the image data with or without the ascertained image objects to a remote data processing device;
c3b) assigning object properties to the transmitted image data;
c3c) weighting connections between neurons of the artificial neural network based on the generated assignment of image objects and object properties; and
c3d) transmitting the ascertained connection weights to at least one rock processing machine or rock processing plant.

34. The method of claim 33, wherein in step c3d) the ascertained connection weights are transmitted to at least two of the rock processing machines.

35. The method of claim 34, wherein the rock processing plant comprises the at least two rock processing machines sequentially arranged in a common rock material flow of the rock processing plant, and in step c3d) the ascertained connection weights are further transmitted to the rock processing plant.

36. The method of claim 33, wherein in step c3d) the ascertained connection weights are transmitted to the rock processing plant, wherein the rock processing plant comprises the at least two rock processing machines sequentially arranged in a common rock material flow of the rock processing plant.
